(19) United States
(12) Patent Application Publication
(10) Pub. No.: US 2020/0287845 A1
(43) Pub. Date: Sep. 10, 2020

(54) METHOD AND SYSTEM FOR A GEOGRAPHICAL HOT REDUNDANCY

(71) Applicant: ALSTOM Transport Technologies, SAINT-OUEN-SUR-SEINE (FR)

(72) Inventor: Sergio BEZZECCHI, VILLEBON SUR YVETTE (FR)

(21) Appl. No.: 16/811,500

(22) Filed: Mar. 6, 2020

(30) Foreign Application Priority Data
Mar. 7, 2019 (FR) 1902344

(51) Int. Cl. H04L 12/939; G06F 11/20; H04L 29/08

(52) U.S. Cl. CPC H04L 49/557; G06F 11/2028; G06F 2201/82; H04L 67/1095; G06F 2201/805; H04L 49/555

(57) ABSTRACT

A geographical hot redundancy method includes: a first master computer transmitting to a second slave computer first input data items and a first execution context for the n^{th} execution cycle of an application, first and second replicas being respectively executed on the first and second computers; execution of the first replica, updating the first execution context at the n^{th} cycle end and transmission to the second computer; recovering the first input data items and the first execution context for the n^{th} cycle as the second input data items and second execution context for the n^{th} cycle; executing the second replica in the second execution context for the n^{th} cycle, on the second input data items of the n^{th} cycle, and updating the second execution context at the end of the n^{th} cycle; and checking and verifying consistency by comparing first and second execution contexts at the n^{th} cycle end.

### BACKGROUND OF THE INVENTION

### Field of the Invention

The present invention relates to methods and systems for hot redundancy.

### Description of the Related Art

In order to provide a certain functionality, an information system comprises a safety computer that executes, in a cyclical manner, an appropriate application.

A safety computer is an intrinsically safe computer. It is for example based on a 2oo2 (“two out of two”) architecture, which comprises two computing units, preferably diversified with respect to one another. These two units are arranged in parallel with each other in a manner so as to receive, at all times, the same inputs. The outputs of the two computing units are routed to an evaluation unit (or voter), either hardware or software, which delivers an output only if the outputs from the two computing units are identical to each other. Otherwise, a restrictive safety output is generated by the evaluation unit. In this manner, the outputs of a safety computer are guaranteed with a certain confidence level.

Other architectures are known to the person skilled in the art, however it can be seen that the architectures capable of satisfying the safety and availability requirements specific to the railway sector are based on the conventional architectures 2oo2, 2oo3 or coded monoprocessor. It is to be noted that the advantage of the 2oo2 or 2oo3 composite architectures lies in the possibility of operationally implementing conventional IT/computing components (COTS for “Component Of The Shelf”).

The increase in the overall rate of availability of the functionality offered by the information system is obtained by the aggregation of computing means operating in parallel, in a manner such that one means can immediately take over from another failing means.

Such redundancy, referred to as hot redundancy, of the computing means is for example presented in the patent document EP 1 764 694 B1, which discloses a system comprising a first master safety computer and a second slave safety computer, that duplicates the first master safety computer. Each computer executes a replica of the same application. The outputs generated at each cycle of execution of the application by the two safety computers are compared in order to check and verify the consistency of/between the two computers and the nominal operation of the system. This verification of the consistency in the execution of each of the replicas of the application is based on the presence of a hardware control device, of a bidirectional synchronisation link between the computers for strict synchronisation of the master and slave computers, and a hardware device for processing the outputs of the two computers.

Perfect synchronisation of the two safety computers is necessary in order to be certain that the comparison of the output data items generated by each computer relates to/focuses on the data computed over the course of the same application execution cycle, based on/from the same batch of input data items.

Thus, the system presented in the patent document EP 1 764 694 B1 includes the means for synchronisation and communication through the bidirectional synchronisation link between the two safety computers thereby enabling these latter to remain strictly synchronised.

In order not to introduce distortion, this link must be efficient and dedicated. It is typically a cable line, a data bus, or a private communications network. These constraints impose the requirement for the length of this synchronisation link to be short, which implies that the two safety computers, the master and slave, are placed in close proximity to one another.

Because of the presence of this synchronisation link and occasionally of the evaluation device for evaluating consistency/arbitration, the two safety computers are therefore located in the same geographical location.

However, such a system does not provide the means to overcome common mode failures. For example, in the event a fire in the room where the first safety computer is located, were to result in this first computer being put out of operation, there's the risk of it also resulting in the second computer being put out of operation. This second computer would then not be able to play its role in providing redundancy for the failed master computer and the functionality offered by the information system would no longer be available.

There is therefore a need for a geographical hot redundancy that allows the redundant computers to be separated by a physical distance in order to avoid the common failure modes. In this way, in the event of failure of the first master computer, the second slave computer is not a priori affected and, upon noting that the first computer has failed, is able to take over control and ensure the continuity of the availability of the system's functionality.

However, separating the two safety computers results in losing the possibility of precisely synchronising them and, consequently, of comparing their outputs in order to determine whether one or the other of the safety computers is experiencing a failure. It therefore no longer becomes possible to arbitrate between the two computers as to which one of them is to operate as a master and which one is to operate as a slave.

### SUMMARY OF THE INVENTION

The object of the invention is to respond to this problem, by proposing a method for geographical hot redundancy.

In order to accomplish this, the object of the invention is a hot redundancy method for geographical hot redundancy between a first safety computer and a second safety computer connected to each other by a generic communication network, with the first safety computer cyclically executing a first replica of an application and the second safety computer, providing redundancy for the first safety computer, cyclically executing a second replica of the said application, the method, in normal operation while the first safety computer operates as a master computer and the second safety computer operates as a slave computer, being characterised by the steps consisting in:
a) the transmission by the first safety computer to the second safety computer of a message comprising the first input data items for an n^{th} cycle and all or part of a first execution context for execution of the application for the n^{th} cycle;
b) the execution, during the nth cycle, of the first replica of the application on the first safety computer and updating of the first execution context for execution of the application at the end of the n^{th} cycle;
c) the transmission by the first safety computer to the second safety computer of a first output quantity corresponding to all or part of the first execution context at the end of the n^{th} cycle;
d) the reception by the second safety computer of the message and the recovery of the first input data items for the n^{th} cycle and of all or part of the first execution context for the n^{th} cycle contained in the message as the second input data items and the second execution context for the n^{th} cycle on the second safety computer;
e) the execution, during the n^{th} cycle, of the second replica of the application on the second safety computer in the second execution context for the n^{th} cycle, on the second input data items for the n^{th} cycle, and updating of the second execution context at the end of the n^{th} cycle;
f) the checking and verification of the consistency between the first and second safety computers by comparing a second output quantity corresponding to all or part of the second execution context at the end of the n^{th} cycle on the second safety computer with the first output quantity at the end of the n^{th} cycle received from the first safety computer.

According to particular embodiments, the method comprises one or more of the following characteristic features, taken into consideration in isolation or in accordance with all technically possible combinations:
in the event of a difference between the first and second output quantities, a training step in order to restore consistency between the second safety computer and the first safety computer, the said training step consisting in: producing an image of the first execution context at the end of the n^{th} cycle on the first safety computer; transmitting the image to the second safety computer; initialising the second execution context on the second safety computer with the image received; and executing the second replica of the application on the second safety computer during the cycle that follows the n^{th} cycle;
during the training step, the second safety computer is maintained in a quarantine step during a predetermined number of cycles in order to check and verify the consistency between the first and second safety computers by effectively implementing the steps a) to f) for each of the cycles of the quarantine step, and, in the event of a positive verification, to restore the redundancy between the first and second safety computers;
the first and second output quantities at the end of the n^{th} cycle correspond to a signature of the execution context corresponding to the end of the n^{t} cycle, a signature algorithm being chosen in accordance with a required level of operational safety;
the second safety computer performs a switch over step of switching over from slave to master when it no longer receives a message from the first safety computer for a predetermined period of time;
when the first safety computer detects a failure, it adopts a safe fallback state and transmits a confirmation of the fallback state adopted to the second safety computer, with the second safety computer initiating a switch over step of switching over from slave to master after having received the said confirmation;
the method includes a step of maintaining the communication by operationally deploying an additional safety computer that fulfills the role of a control computer, connected on the one hand to the first safety computer and on the other hand to the second safety computer, with the second safety computer initiating a switch over step of switching over from slave to master following the interruption of communication with the first safety computer, after having interrogated the additional computer and having received from the latter a confirmation that the first safety computer is not responding;
in the event of a difference between the first and second output quantities being detected for the first time since a time period greater than a predetermined threshold value, the predetermined threshold value preferably being greater than the duration of two execution cycles, a re-execution step for re-executing an execution cycle is provided for; and
the transmission by the first safety computer to the second safety computer of a message comprising the first input data items for an n^{th} cycle and all or part of a first execution context for execution of the application for the n^{th} cycle and/or the transmission by the first safety computer to the second safety computer of a first output quantity corresponding to all or part of the first execution context at the end of the n^{th} cycle, includes the sending by the first safety computer of the correction codes, the said correction codes making it possible for the second safety computer to reconstruct the frames lost or deleted by the communication network.

The invention also relates to a redundancy system for geographical hot redundancy comprising a first safety computer and a second safety computer connected to each other by a generic communication network, with the first safety computer cyclically executing a first replica of an application and the second safety computer, providing redundancy for the first safety computer, cyclically executing a second replica of the said application, the system being configured so as to operationally implement a method in accordance with the preceding method.

According to particular embodiments, the system comprises one or more of the following characteristic features, taken into consideration in isolation or in accordance with all technically possible combinations:
the communication network is a wide area network operationally implementing an ETHERNET protocol;
the second safety computer is placed at a distance from the first safety computer in a manner so as to avoid the common failure modes;
an additional safety computer that fulfills the role of a control computer connected on the one hand to the first safety computer and on the other hand to the second safety computer; and
the first and second safety computers execute a safety algorithm making it possible to generate, from an execution context for execution of the application at the end of an n^{th} cycle, a signature as an output quantity for the checking and verification of the consistency between the first and second safety computers.

### BRIEF DESCRIPTION OF THE DRAWINGS

The invention and its advantages will be better understood upon reading the detailed description which follows of a particular embodiment, given solely by way of non-limiting example, this description being made with reference to the appended drawings in which:

FIG. 1 is a schematic representation of an embodiment of an information system having geographical hot redundancy;

FIG. 2 is a representation in block diagram form of the part executed by a master computer, of an embodiment of the method for geographical hot redundancy in the system shown in FIG. 1;

FIG. 3 is a representation in block diagram form of the part executed by a slave computer, of an embodiment of the method for geographical hot redundancy in the system shown in FIG. 1;

FIG. 4 is a representation in block diagram form of a training step for training a computer prior to restoring redundancy; and,

FIG. 5 is a representation in block diagram form of additional conditions to be checked and verified prior to a slave-master switch over of a computer.

### DESCRIPTION OF THE PREFERRED EMBODIMENTS

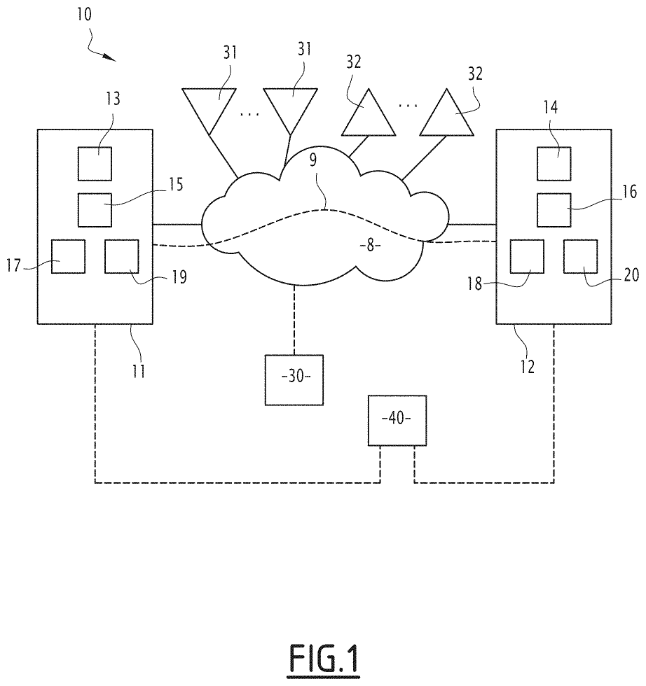

In FIG. 1, the system 10 is built around an extended generic communication network 8. It is for example a network of the WAN type (acronym for “Wide Area Network”) that supports a packet switching protocol, for example based on the ETHERNET communication protocol.

Preferably, the network 8 is duplicated in order to increase the robustness of the system 10, with each IT equipment unit then having two input/output ports, each port being connected to one of the networks. For reasons of clarity, in the following sections, the system will be considered as having one single communication network.

The system 10 includes a first safety computer 11 connected to the network 8. The computer 11 conforms to the safety computer presented in the introduction to this patent application. The first computer 11 executes a first replica 13 of an application which, when executed, offers a functionality, for example a functionality for managing a plurality of signalling equipment units arranged along a railway track.

In a general manner, the execution of an application is carried out over the course of successive cycles, with each cycle comprising an execution step of executing the application, which consists in executing one or more elementary processes of this application.

For example, during one execution step, the processor of the computer executes at least a first process during a certain allocated time. Thereafter the processor proceeds to the execution of another application. Then, for the execution step over the course of the subsequent cycle, the processor again commences the execution of this first process.

The execution of an application by a computer is comparable to a state machine. The use of variables enables maintaining the current state of this machine. The set of these variables constitutes the execution context for execution of the application considered, that is to say the location wherein, at the current time instant, the execution of the application is occurring. The context is saved and stored.

Thus, the first context 15 of the first replica 13 of the application is for example saved and stored in a determined space of the memory storage of the first computer 11.

At the start of a cycle, prior to executing the application, the processor loads into the memory storage associated with it the context of the application to be executed in order to be able to resume the execution of this application starting from the situation in which it happened to be in the previous cycle.

The context includes different types of variables, in particular essential variables (such as for example the attributes of the cycle, safety time, etc.) and other variables, such as the state variables of the application (which therefore are dependent on each application).

If two computers executing replicas of the same given application have the same execution context at the end of cycle N, this signifies that they are in the same state. This is an allusion to consistency of execution.

The first input data items 17 collected by the first computer 11 and to be used during the execution of the first replica 13 of the application are saved and stored in a dedicated memory storage space.

The first output data items 19 obtained during the execution of the first replica 13 of the application are saved and stored in a dedicated memory storage space.

One cycle lasts for example 200 ms. Where each cycle results in the generation of one output data item of such type as a command for an equipment unit on the track, the system 10 provides the capability of generating about five commands per second.

It should be noted that, taking into account the typical process or reaction times characteristic of railway systems (for example the reaction time for the actuation of a switch), a command may be generated with a delay of one or two cycles without this degrading the level of safety of the railway installation.

The system 10 includes at least one safety computer providing redundancy for the first computer 11. Thus the system 10 includes a second safety computer 12 connected to the network 8. The second computer 12 is materially identical to the first computer 11. It executes a replica of the application that is executed on the first computer 11. This replica is a second replica 14.

A second context 16 of the second replica 14 of the application is saved and stored in a determined space of the memory storage of the second computer 12.

The second input data items 18 collected by the second computer 12 and to be used during the execution of the second replica 14 of the application are saved and stored in a dedicated memory storage space.

The second output data items 20 obtained during the execution of the second replica 14 of the application are also saved and stored in a dedicated memory storage space.

The system 10 also includes a plurality of peripherals connected to the network 8.

The peripherals comprise data acquisition peripherals 31 for acquiring data, that are capable of transmitting the acquired data to the safety computers 11 and 12, for example by operationally implementing a multicast broadcast protocol on the network 8.

The peripherals also include actuation peripherals 32 that are capable of receiving commands sent by the safety computers 11 and 12.

Optionally, the system 10 is interfaced with other computers and systems, referred to as external computers and systems, 30, through the network 8.

At each time instant, a single safety computer of the system 10 functions as a master computer having absolute control of the system: it is the only safety computer expected to be produce the output data items and to transmit the same as commands to the actuating peripherals 32 or to the external systems 30. The or each other safety computer operates as a slave and the output data items that it computes are not used by the peripheral devices connected to the network.

In the nominal operating mode of the system 10, the first computer 11 operates as the master computer of the system and the second computer 12 operates as the slave computer.

Thanks to the network 8, the computers and the peripherals of the system 10 may be installed in various locations.

In particular, the first and second safety computers 11 and 12 are hosted in mutually distant locations in order to as far as possible avoid common mode failures. The first and second computers 11 and 12 may thus for example be provided at each of the terminus stations of the metro line the signalling of which they manage.

The first master computer 11 communicates with the second slave computer 12 through the network 8. Typically, in the system 10, the communication between the first and second computers 11 and 12 (link 9 in FIG. 1) takes place through a first local area network, to which the first computer 11 is connected; a first gateway; a public or private network of the WAN type; a second gateway; and a second local area network to which the second computer 12 is connected.

The use of a network, such as the network 8, does not provide the means to ensure that a multicast input packet produced by one of the data acquisition peripherals 31 and sent to the computers 11 and 12, has in fact been received by the two computers. Similarly, the network 8 does not provide the means to ensure that two packets sent one after the other by the first computer 11 are in fact received in the same order by the second computer 12, nor that the time period separating these two packets during their outputting is maintained during their transmission. It could even so happen that a packet is lost during the transmission thereof on the network. It is therefore not possible to strictly synchronise the first and second computers 11 and 12 through the network 8, or to ensure that they receive exactly the same input data items.

According to the invention, the slave computer is therefore authorised to complete, at its own pace, the execution of the application, without being required to maintain close adherence temporally to the execution of the master computer.

Since it is no longer possible to closely synchronise the master and slave computers, a redundancy method 100 for geographical hot redundancy is operationally implemented by the system 10 in order to maintain consistency between the master and slave computers.

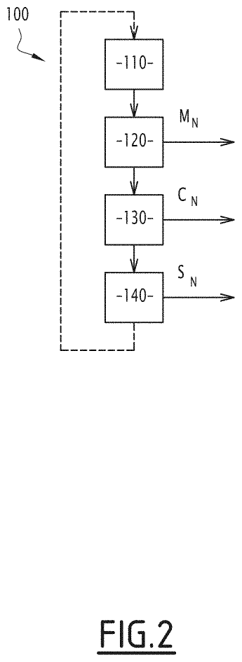

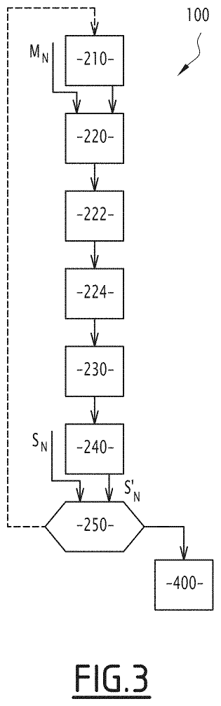

The method 100 makes it possible for the master computer to maintain the consistency of the one or more slave computer(s) as will now be presented with reference to FIGS. 2 and 3.

FIG. 2 corresponds to the part of the method 100 carried out on the first safety computer 11 that acts as the master.

At the end of the cycle N−1, in the step 110 the first computer 11 receives, from the various different peripherals 31, the input data items 17 which will need to be processed in the cycle N. Each input data item acquired by the first computer 11 is dated and signed in order to ensure the integrity and the uniqueness of this input data item. Each input data item is saved and stored, as the first input data item, in the corresponding space of the memory storage of the first computer 11.

At the start of the subsequent cycle N, in the step 120, the first computer 11, by reading the corresponding spaces from its memory storage, prepares an initial message comprising all of the first input data items 17 for the cycle N, and a portion of the first execution context 15 for the cycle N.

For example, an initial message indicates the cycle number, the values of the first input data items for this cycle, and the values of the essential variables of the first execution context of the application for this cycle.

The initial message for the cycle N, M_{N}, is transmitted to the second computer 12 via the network 8.

Advantageously, the transmission by the first computer 11 of its input data items and of the portion of its context, is accompanied by the correction codes that enable the second computer 12 to reconstruct any possible frames missing in the message M_{N}.

Then, during the step 130, the first computer 11 executes the first replica 13 of the application in the first context 15 for the cycle N, on the first input data items 17 for the cycle N. This consequently results in the obtaining of the first output data items 19 for the cycle N.

At the end of step 130, the values of the variables of the first context 15 are updated. The first context 15 updated at the end of the cycle N will be the context to be used for starting the step of executing the first replica 13 of the application in the subsequent cycle N+1.

The first output data items 19 for the cycle N are transmitted to the peripheral devices 32 as commands C_{N}.

Then, in the step 140, the first computer 11 computes a first signature 20 of the first context 15 that is updated at the end of the cycle N. This first signature for the cycle N, S_{N}, is established over all of the critical variables of the first context 15 of the application of interest.

The first computer 11 transmits the first signature S_{N} for the cycle N to the second computer 12 via the network 8.

Then, on the first computer 11, for the subsequent cycles, the steps 110 to 140 are iterated.

FIG. 3 corresponds to the part of the method 100 carried out on the second safety computer 12 that acts as a slave.

In the cycle N−1, in the step 210, the second computer 12 receives from the various different peripherals 31 the input data items which are saved and stored as second input data items 18 for the cycle N. Each input data item acquired by the second computer 12 is dated and signed in order to ensure the integrity and the uniqueness of this input data item.

In the cycle N, in the step 220, the second computer 12 processes the message M_{N} for the cycle N that it has received from the first computer 11.

In the step 222, the second computer 12 assigns to the variables of the second context 16 for the cycle N, the values of these same variables indicated in the message MN.

In the step 224, the second computer 12 proceeds to perform a complete reconciliation of the second input data items 18 for the cycle N. In order to do this, the second computer 12 considers the first input data items of the message M_{N} to be constituting the entirety of the second input data items 18 that it will have to process in the cycle N. This therefore involves a cloning by the slave computer 12 of the first input data items provided by the master computer 11 in the message M_{N}. The input data items collected in the step 210 are therefore harmonised with the first input data items provided by the first computer 11.

Then, during the execution step 230, the second computer 12 executes the second replica 14 of the application in the second context 16 for the cycle N on the second input data items 18 for the cycle N, so as to in a manner compute the second output data items 20 for the cycle N.

At the end of the execution step 230, the values of the variables of the second context 16 are updated.

In the step 240, the second computer 12 computes a second signature S′_{N} of the second context 18 that is updated at the end of the cycle N. The second computer 12 here operationally implements the same signature algorithm as that used by the first computer 11.

In the step 250, the second computer 12 certifies the alignment of its context with that of the first computer 11 by comparing, for the same cycle N, the second signature S′_{N}, which it has computed, and the signature S_{N}, which it received from the first computer 11.

In the event of the two signatures compared being identical to each other, the second computer 12 attests to its correct alignment with respect to the computer 11. The steps 210 to 250 are iterated for the subsequent cycle. The system 10 therefore remains in the nominal operating mode, with the first computer 11 operating as a master and the second computer 12 operating as a slave.

Thus, as has just been presented, the slave computer, in an autonomous, secure and safe manner, attests to the consistency over the master computer.

The use of a signature instead of the values of the variables of the context ensures functional independence between the computers, with the hash function of the signature algorithm being chosen depending on the magnitude of the critical variables to be signed, in order for the probability of collision to be negligible as compared to the level of integrity required by the system (SIL level).

On the other hand, if the two signatures compared are different, the second computer 12 concludes that it has lost its alignment with the first computer 11 and proceeds to a step 400 of training.

Preferably, the method goes to the step 400, after at least one re-execution of an application execution cycle and the confirmation of the finding of a loss of alignment between the first and second safety computers.

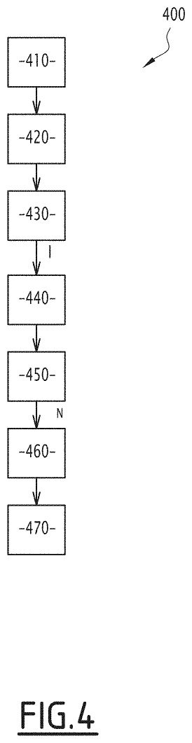

FIG. 4 represents the training step 400 for establishing or re-establishing the consistency of a safety computer.

This step is carried out following a loss of consistency by a slave computer with respect to a master computer as detected in the step 250. It may also be implemented following a period of isolation of a slave computer which ends, for example, by re-establishing communication with a master computer or a control computer, or even when the computer after remaining isolated due to a fault or failure is returned to service, with the latter being necessarily misaligned with respect to the master computer.

Step 400 involves an integral replication of the context of the master computer. For example, the entire content of the first context 15 at the end of the cycle N is transferred from the first computer 11 to the second computer 12 in order to completely re-initialise the second context 12 and relaunch the execution of the second application starting from cycle N+1 from this replica.

In a first step 410, it is necessary to verify that the second computer 12 is not affected by a hardware failure. This is done by carrying out the appropriate diagnostics.

In the affirmative, in the step 420, an image I_{N} is produced of the section of the memory storage of the first computer 11 which contains the first context 15 at the end of the cycle N of execution of the application of interest.

Then, in the step 430, this image I_{N} for the cycle N is transmitted, via the network 8, to the computer 12.

In the step 440, the section of the memory storage of the second computer 12 which contains the second context 16 of the computer 12 is initialised based on the image I_{N} received.

In the step 450, starting from the cycle N+1, the execution of the second replica 14 of the application is launched in the second context 16.

A quarantine step 460 makes it possible to observe the evolving change in the consistency of the slave computer with respect to the master computer over a plurality of cycles. As in the method 100, the master computer 11 transmits, at the start of the cycle N+k, the first input data items to be taken into account as well as the relevant part of the first context 15 for the cycle N+k, and, at the end of the cycle N+k, a first signature on the first context at the end of the cycle N+k. At the end of the cycle N+k, the slave computer 12 compares a second signature which it has computed on the second context 16 at the end of the cycle N+k with the first signature received from the master computer 11 in order to check and verify the consistency between the master computer and slave computer.

Finally, if the quarantine step provides proof of the consistency of the slave computer with respect to the master computer over a plurality of cycles, the redundancy is reestablished in the step 470.

By way of a variant, when the size of the image I_{N} produced in the step 420 is substantial, the time necessary for its transmission during the step 430 from the master computer to the slave computer may exceed the time duration of an execution cycle, depending in particular on the latency and the bandwidth of the network. However, since a time difference between the master computer and the slave computer is permissible, even if the transmission is spread out over multiple cycles, once the transmission is complete and the memory storage of the slave computer is reinitialised, the latter resumes execution of the replica of the application starting from the cycle N+1 and makes up for its delay during the quarantine step.

The ability to make up the delay in execution and catch up with the master computer requires a certain margin in terms of computing capacity on the part of the slave computer. However, this need for additional computing capacity may be minimised by taking into account the fact that the slave computer does not have to produce and transmit commands to the peripherals.

The training step 400 therefore makes it possible to resynchronise the slave computer with the master computer and thereby reestablish the redundancy.

The slave computer once it is resynchronised remains in reserve, without it being required to resume the role of master as long as the current master computer remains operational.

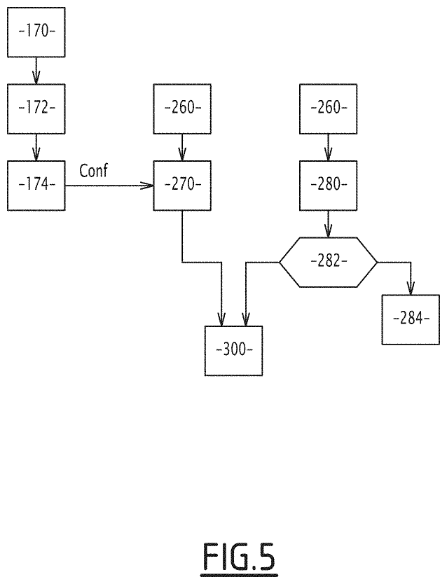

The method according to the invention provides for the possibility of the slave computer switching over to become master. This is what will now be presented in FIG. 5.

The method 100 provides for a step 260 according to which the second computer 12, upon each reception of a message from the first computer 11 (initial message M_{N} or signature S_{N}) reinitialises a time counter.

If the second computer 12 finds at some point in time, that the value of this time counter is greater than a predetermined time period, thus indicating that no message has been received from the first computer 11, the second computer 12 concludes that the first computer 11 is faulty and goes to the step 300 of switching over from slave to master.

In the system 10, it is therefore the slave computer which decides to take control when it no longer receives a message from the master computer for a predetermined time period.

However, certain constraints are to be checked and verified prior to the slave computer actually indeed initiating the step 300 of switching over from slave to master in order to gain robustness.

The steps of the method 100 may advantageously be carried out prior to authorising the changeover from master to slave.

In effect, in a general way, the fault tolerance at the system level requires compliance with the following rules:

1. Preventing erroneous commands from being delivered to the controlled peripheral devices.

2. Preserving the consistency of the context between the master computer and the slave computer in order to avoid a lack of coordination between these computers leads, at the time of the slave-master switch over, to a situation of dangerous discontinuity in the flow of commands at the system level. It should be noted that this discontinuity can be temporal (hole), but also in content (an output data item that changes value accidentally).

Indeed, in order for the switching of control between computers to have no impact on the controlled peripherals, continuity of the flow of commands is to be ensured.

If the switching of control between computers causes a temporary interruption of this flow of commands, this interruption must remain below a safety interval so that there are no consequences at the system level. In the same way, the change in the values of the output data items during the switch over should remain functional.

The definition of a safety interval is specific to each system, to each functionality. Its value is also dependent on the characteristic features of the network (message loss rate, latency). In general, the safety interval is chosen at a minimum value corresponding to the duration of an execution cycle increased by the (value of) latency introduced by the network.

The first rule is satisfied by each safety computer 11 and 12, since such a computer generates safety commands only and it automatically assumes a restrictive fallback condition in the event of failure.

In order to comply with the second rule, two conditions are necessary:

i. Ensuring, safely, the consistency between the redundant safety computers.

ii. Ensuring that only one of the safety computers is the master computer of the system at all times.

The first constraint is adhered to by the method 100, in particular the step 250 of checking and verifying the alignment of the contexts, but also of taking into account the same input data items and the same critical variables of the context for the execution of the application.

The second condition is linked to the detection of the failure of the master computer, to securing and restoring it to safety condition, and the switching of the slave computer from the slave condition to that of the master, in order to replace the faulty master computer.

The exclusion of the master computer is an obligatory consequence of its failure. In fact, as a safety computer, it adopts a restrictive fallback condition in the event of failure.

Preferably, it should also be possible to comply with the second rule in the event of partitioning of the communication network 8 which would result in it becoming impossible to maintain the communication between the master and slave computers 11 and 12 and consequently also the alignment of their contexts. If, for example, following a serious network failure, the master computer were to find itself completely isolated from the slave computer, the latter would switch over from slave to master. This situation runs contrary to safety since each partition of the network would have a different master computer, and these two masters would not be able to maintain mutual consistency due to the lack of communication between them.

To avoid this risk, two strategies, that are not mutually exclusive, are possible, as illustrated in FIG. 5.

The first strategy consists in organising concerted interaction between the first computer 11 that has failed and the second slave computer 12 that intends to switch over from slave to master. According to this first strategy, the first failing computer 11 delegates its role.

In order for this to occur, after having detected its own failure in the step 170, the first computer 11 places itself, in the step 172, in a restrictive fallback condition and sends, in the step 174, a confirmation message Conf of this retreat to safety to the second computer 12.

It is only when the second computer 12 receives this confirmation message, for example in a step 270 after the step 260, that it is able perform the step 300 of switching over from slave to master.

The network 8 must however be available to transmit this confirmation. If such is not the case, the switching over of the slave computer will not take place.

A second strategy consists in providing an additional safety computer 40 in the system 10, placed in a site that is separate from the master and slave computers and with appropriate means of communication independent from the network 8. This computer 40 fulfills the role of a control computer providing for an external acknowledgment and/or arbitration in order to properly assign the master function, while also foiling any potential double master situation, in particular in the case of network partitioning 8.

According to this second strategy, in the event of loss of communication between the master and slave computers resulting from a partitioning of the network or from a complete failure of the master computer, the control computer serves to ascertain and validate in an independent manner, the connectivity between the master and slave computers, as well as the condition thereof. In the event of network partitioning, a computer that loses its connectivity with the control computer adopts a restrictive fallback condition.

Thus for example, after step 260, in the step 280, the second computer 12 sends a request to consult the control computer 40.

If no response is received within a predefined time period (step 282) indicating that the control computer 40 cannot be reached, the second computer 12 infers a situation of isolation and adopts a safe fallback condition (step 284).

On the other hand, if the second computer 12 retains its connectivity with the control computer 40 and if the control computer 40 responds by indicating the absence of any other master computer in the partition, it will only be upon receipt of this response that the second computer 12 would be able to perform the step 300.

In this second strategy, since the ability to switch from slave to master depends on the availability of the control computer 40, this control function can advantageously itself be redundant. In this case, the master and slave computers can vote on the conditions ascertained and validated by each of the accessible control computers.

If the switch over from slave to master (step 300) occurs at cycle N+1, the second computer 12 performs the execution of the second replica 14 of the application in the second context 16 determined at the end of the cycle N with the second input data items 18 collected by the second computer 12 during the step 210 of the cycle N. Then the second output data items 20 computed in the cycle N+1 are transmitted by the second computer 12, which now acts as master, to the peripherals 32.

At the level of a peripheral device 32, a transient of the time interval between two successive commands appears during the switch over. Indeed, the first command originates from the first computer 11 before it fails and the second command, which follows the first command, originates from the second computer 12 which has become the master. During the switch over, the interval between these first and second commands may extend over a few cycles, but this has no consequence on the system as indicated above.

It should be noted that in the case where a master computer has redundancy backed by a plurality of slave computers, coordination between slave computers must be established so as to ensure that one and only one of these slave computers replaces the faulty master computer. In order to do this, it suffices to establish in advance a hierarchy among computers thereby making it possible to determine the slave computer that ought to switch from slave to master in order to replace a faulty master computer. For example, this hierarchy takes the form of an ordered list of identifiers of the computers involved in ensuring the redundancy of the same functionality. Then, the computer replacing the current master computer in case of failure of the latter is the computer whose identifier follows that of the current master computer in the list.

By means of the method previously presented, the consistency between the master and slave computers is ensured, thus replacing the strict synchronisation taught in the prior art.

Even if the cycles of execution of replicas of the applications are temporally offset with respect to each other, the method makes it possible to ensure that the outputs produced for the same given execution cycle are identical.

Advantageously, to make the process resilient, in particular against the loss of packets corresponding to a part of a message or to a defective reception of messages originating from the peripherals 31, the master computer can transmit the same message several times, or produce correction frames that serve to enable the slave computer to detect and compensate for errors or losses, for example, by requesting from the master the retransmission of all or part of the message.

It should be noted that, unlike for example the system presented in document EP 1 767 694 B1 which includes a command-control device that provides the means to, at any time, arbitrate between the two computers and adjudicate as to which one ought to operate as master and which one as slave, the present system does not necessarily include such an additional device, even though in an alternative embodiment it is envisaged to use a control computer. In the system presented here, it is the slave computer which decides to take control, in particular when it no longer receives messages from the master computer. The system is therefore immunised against the failures of such an additional command-control device.

The person skilled in the art will recognise that the system presented here above makes possible geographical hot redundancy such as to ensure a high level of availability of the functionality offered by the system, without however requiring strict synchronisation of the redundant safety computers.

The flexible coordination mechanisms operationally implemented between the redundant safety computers permit the removal of the dedicated link between these IT resources.

The redundant safety computers can physically be at great distances away from each other, thereby making it possible to avoid common failure modes. By means of such geographical redundancy, greater availability of the functionality provided by the system is obtained.

Since hot redundancy is ensured at the system level, any applications borne on the computers can benefit from it in a transparent manner, without the need for specific studies or certifications at the application level of a particular strategy.

Taking into account the latency introduced by a generic communication network, the system presented is particularly well suited to the railway sector, in particular to the functionalities of train traffic control, and notably the signalling functionalities.

The efficiency of the redundancy depends on the performance of the network which links the redundant computers. If the characteristics and features of the network deteriorate, execution at the level of the slave(s) will be delayed and, if the problem persists, the master-slave consistency could be lost. Thus, a preferred solution would be the use of a network dedicated to communication among safety computers or at least a network that allows for the reservation of a suitable bandwidth in order to ensure a minimum level of service quality for communications between master and slave.

1. A method for a geographical hot redundancy between a first safety computer and a second safety computer, the first and second safety computers being remote from each other to avoid failure common modes, the first and second safety computers being connected to each other by a generic communication network without a synchronisation link allowing a strict synchronisation between the first and the second safety computers, the first safety computer cyclically executing a first replica of an application and the second safety computer, providing a redundancy for the first safety computer, cyclically executing a second replica of the application, the method, in normal operation, while the first safety computer operates as a master computer and the second safety computer operates as a slave computer, comprising the steps consisting in:
a) a transmission by the first safety computer to the second safety computer of a message comprising first input data items for an n^{th} cycle and all or part of a first execution context for execution of the application for the n^{th} cycle;
b) an execution, during the n^{th} cycle, of the first replica of the application on the first safety computer and updating of the first execution context of the application at the end of the n^{th} cycle;
c) a transmission by the first safety computer to the second safety computer of a first output quantity corresponding to all or part of the first execution context at the end of the n^{th} cycle;
d) a reception by the second safety computer of the message and a recovery of the first input data items for the n^{th} cycle and of all or part of the first execution context for the n^{th} cycle contained in the message as second input data items and a second execution context for the n^{th} cycle on the second safety computer;
e) an execution, during the n^{th} cycle, of the second replica of the application on the second safety computer in the second execution context for the n^{th} cycle, on the second input data items of the n^{th} cycle, and an update of the second execution context at the end of the n^{th} cycle;
f) a check and verification of the consistency between the first and second safety computers by comparing a second output quantity corresponding to all or part of the second execution context at the end of the n^{th} cycle on the second safety computer with a first output quantity at the end of the n^{th} cycle received from the first safety computer.

2. The method according to claim 1, comprising, in the event of a difference between the first and second output quantities, a training step in order to restore a consistency between the second safety computer and the first safety computer, the said training step consisting in: producing an image of the first execution context at the end of the n^{th} cycle on the first safety computer; transmitting the image to the second safety computer; initializing a second execution context on the second safety computer with the image received; and executing the second replica of the application on the second safety computer during a cycle that follows the n^{th} cycle.

3. The method according to claim 2, wherein, during the training step, the second safety computer is maintained in a quarantine step during a predetermined number of cycles in order to check and verify the consistency between the first and second safety computers by effectively implementing the steps a) to f) for each of the cycles of the quarantine step, and, in the event of a positive verification, to restore the redundancy between the first and second safety computers.

4. The method according to claim 1, wherein the first and second output quantities at the end of the n^{th} cycle correspond to a signature of the execution context at the end of the n^{th} cycle, a signature algorithm being chosen in accordance with a required level of operational security.

5. The method according to claim 1, wherein the second safety computer performs a switch over step of switching over from slave to master when the second computer no longer receives a message from the first safety computer for a predetermined period of time.

6. The method according to claim 1, wherein, when the first safety computer detects a failure, the first safety computer adopts a safe fallback state and transmits a confirmation of the safe fallback state adopted to the second safety computer, with the second safety computer initiating a switch over step of switching over from slave to master after having received the confirmation.

7. The method according to claim 1, including a step of maintaining a communication by operationally deploying an additional safety computer that fulfills the role of a control computer, that is connected both to the first safety computer as well as to the second safety computer, with the second safety computer initiating a switch over step of switching over from slave to master following an interruption of the communication with the first safety computer, after having interrogated the additional safety computer and having received from the latter a confirmation that the first safety computer is not responding.

8. The method according to claim 1, wherein, in case of a difference between the first and second output quantities being detected for the first time over a time period greater than a predetermined threshold value, a re-execution step for re-executing an execution cycle is provided for.

9. The method according to claim 1, wherein the transmission by the first safety computer to the second safety computer of a message comprising first input data items for an n^{th} cycle and all or part of a first execution context for execution of the application for the n^{th} cycle and/or the transmission by the first safety computer to the second safety computer of a first output quantity corresponding to all or part of the first execution context at the end of the n^{th} cycle, includes a sending by the first safety computer of correction codes, the said correction codes making it possible for the second safety computer to reconstruct the frames lost or deleted by the communication network.

10. A system for geographical hot redundancy comprising a first safety computer and a second safety computer connected to each other by a generic communication network, with the first safety computer cyclically executing a first replica of an application and the second safety computer, providing redundancy for the first safety computer, cyclically executing a second replica of the said application, the system being configured so as to operationally implement a method according to claim 1.

11. The system according to claim 10, in which the communication network is a wide area network operationally implementing an ETHERNET protocol.

12. The system according to claim 10, in wherein the second safety computer is placed at a distance from the first safety computer in a manner so as to avoid failure common modes.

13. The system according to claim 10, further comprising an additional safety computer that fulfills the role of a control computer connected both to the first safety computer as well as to the second safety computer.

14. The system according claim 10, wherein the first and second safety computers execute a safety algorithm making it possible to generate, from an execution context of the application at the end of an n^{th} cycle, a signature as an output quantity for a check and a verification of the consistency between the first and second safety computers.

15. The method of claim 1, wherein in step f) the check and verification are performed by the second safety computer.

16. The method of claim 8, wherein the predetermined threshold value is greater than a duration of two execution cycles.

17. A system for geographical hot redundancy comprising a first safety computer and a second safety computer connected to each other by a generic communication network, with the first safety computer cyclically executing a first replica of an application and the second safety computer, providing redundancy for the first safety computer, cyclically executing a second replica of the said application, the system being configured so as to operationally implement a method according to claim 2.

18. A system for geographical hot redundancy comprising a first safety computer and a second safety computer connected to each other by a generic communication network, with the first safety computer cyclically executing a first replica of an application and the second safety computer, providing redundancy for the first safety computer, cyclically executing a second replica of the said application, the system being configured so as to operationally implement a method according to claim 3.

19. A system for geographical hot redundancy comprising a first safety computer and a second safety computer connected to each other by a generic communication network, with the first safety computer cyclically executing a first replica of an application and the second safety computer, providing redundancy for the first safety computer, cyclically executing a second replica of the said application, the system being configured so as to operationally implement a method according to claim 4.

20. A system for geographical hot redundancy comprising a first safety computer and a second safety computer connected to each other by a generic communication network, with the first safety computer cyclically executing a first replica of an application and the second safety computer, providing redundancy for the first safety computer, cyclically executing a second replica of the said application, the system being configured so as to operationally implement a method according to claim 5.
